(19) United States
(12) Patent Application Publication
(10) Pub. No.: US 2008/0165962 A1
(43) Pub. Date: Jul. 10, 2008

(54) Multistream distributor and multi-descrambler

(75) Inventors: Hideki Kawano, Tokyo (JP); Hideaki Kosaka, Tokyo (JP)

Correspondence Address: BIRCH STEWART KOLASCH & BIRCH, PO BOX 747, FALLS CHURCH, VA, 22040-0747, US

(73) Assignee: Mitsubishi Electric Corporation

(21) Appl. No.: 11/889,313

(22) Filed: Aug. 10, 2007

(30) Foreign Application Priority Data
Jan. 10, 2007 (JP) JP2007-002003

(51) Int. Cl. H04N 7/167

(52) U.S. Cl. 380/212

(57) ABSTRACT

A multistream distributor and a multi-descrambler are provided at low cost, which are capable of displaying a plurality of transport streams corresponding respectively to a plurality of channels on a plurality of receivers or the like. Three first scrambled transport streams received via tuners are time-multiplexed by a multiplexer into one second scrambled transport stream. A multi-descrambler descrambles and encrypts each of the three first scrambled transport streams forming one second scrambled transport stream in correspondence with each of receivers.

### BACKGROUND OF THE INVENTION

1. Field of the Invention

The present invention relates to a multistream distributor and a multi-descrambler, and especially to techniques for descrambling signals for a plurality of different receivers (such as TVs or STBs (set top boxes)) simultaneously using a single device.

2. Description of the Background Art

Conventional multistream distributors and multi-descramblers, using for example CableCARDs specified in the CableCARD Interface 2.0 Specification by CableLabs, descramble a plurality of scrambled transport streams received corresponding respectively to a plurality of channels (broadcast programs) and encrypt the descrambled transport streams for transfer to a single specific receiver (for example, refer to U.S. patent publication 2004/260823, and Cable Television Laboratories, Inc. (CableLabs), CableCARD Interface 2.0 Specification, OC-SP-CCIF2.0-I07-060803, Aug. 3, 2006, pp. 21-22 and 37-40).

The conventional multistream distributors and multi-descramblers handle descrambling, encryption and transfer of transport streams only for a single specific receiver identified by a CableCARD. Thus, even reception and descrambling of a plurality of transport streams corresponding respectively to a plurality of channels are possible, display of those transport streams is limited only to a single specific receiver or a display (monitor) connected thereto. Further, displaying different transport streams on a plurality of different receivers or displays connected thereto, respectively, requires as many CableCARDs as the number of receivers. However, CableCARDs are usually expensive, around a hundred US dollars, so enjoying digital cable television services with a plurality of TVs or STBs at home entails high cost.

The present invention is intended to overcome the aforementioned issues, and its object is to provide a multistream distributor and a multi-descrambler at low cost, which are capable of displaying a plurality of transport streams corresponding respectively to a plurality of channels on a plurality of receivers or the like.

### SUMMARY OF THE INVENTION

It is an object of the present invention to provide a multistream distributor and a multi-descrambler at low cost, which are capable of displaying a plurality of transport streams corresponding respectively to a plurality of channels on a plurality of receivers or the like.

According to an aspect of the present invention, a multistream distributor includes a multiplexer, a multi-descrambler, and a stream transfer interface. The multiplexer time-multiplexes a plurality of first scrambled transport streams corresponding respectively to a plurality of receivers into one second scrambled transport stream. The multi-descrambler descrambles and encrypts each of the plurality of first scrambled transport streams forming the one second scrambled transport stream in correspondence with each of the plurality of receivers, to generate one second encrypted transport stream consisting of a plurality of first encrypted transport streams. The stream transfer interface time-demultiplexes the one second encrypted transport stream into the plurality of first encrypted transport streams and inputs each of the plurality of first encrypted transport streams into a corresponding one of the plurality of receivers.

This provides a low-cost multistream distributor which is capable of displaying a plurality of transport streams corresponding respectively to a plurality of channels on a plurality of receivers or the like.

According to another aspect of the present invention, a multi-descrambler includes a demultiplexer, a descramble circuit, a cipher circuit, and a multiplexer. The demultiplexer time-demultiplexes one second scrambled transport stream, which has been obtained by time-multiplexing the plurality of first scrambled transport streams corresponding respectively to a plurality of receivers, into a plurality of first scrambled transport streams. The descramble circuit descrambles each of the plurality of first scrambled transport streams in correspondence with each of the plurality of receivers, to generate a plurality of descrambled transport streams. The cipher circuit encrypts each of the plurality of descrambled transport streams in correspondence with each of the plurality of receivers, to generate a plurality of first encrypted transport streams. The multiplexer time-multiplexes the plurality of first encrypted transport streams into one second encrypted transport stream.

This provides a low-cost multi-descrambler which is capable of displaying a plurality of transport streams corresponding respectively to a plurality of channels on a plurality of receivers or the like.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram of a system configuration using a multistream distributor according to a first preferred embodiment.

FIG. 2 is a block diagram of a detailed structure of a multi-descrambler according to the first preferred embodiment.

FIG. 3 is a block diagram of a detailed structure of a controller according to the first preferred embodiment.

FIGS. 4A, 4B, and 4C illustrate examples of transport streams (before time multiplexing) according to the first preferred embodiment.

FIG. 5 is an example of a transport stream (after time multiplexing) according to the first preferred embodiment.

FIG. 6 is a block diagram of a detailed structure of a multi-descrambler according to a second preferred embodiment.

FIG. 7 is a block diagram of a detailed structure of a multi-descrambler according to a third preferred embodiment.

### DESCRIPTION OF THE PREFERRED EMBODIMENTS

### First Preferred Embodiment

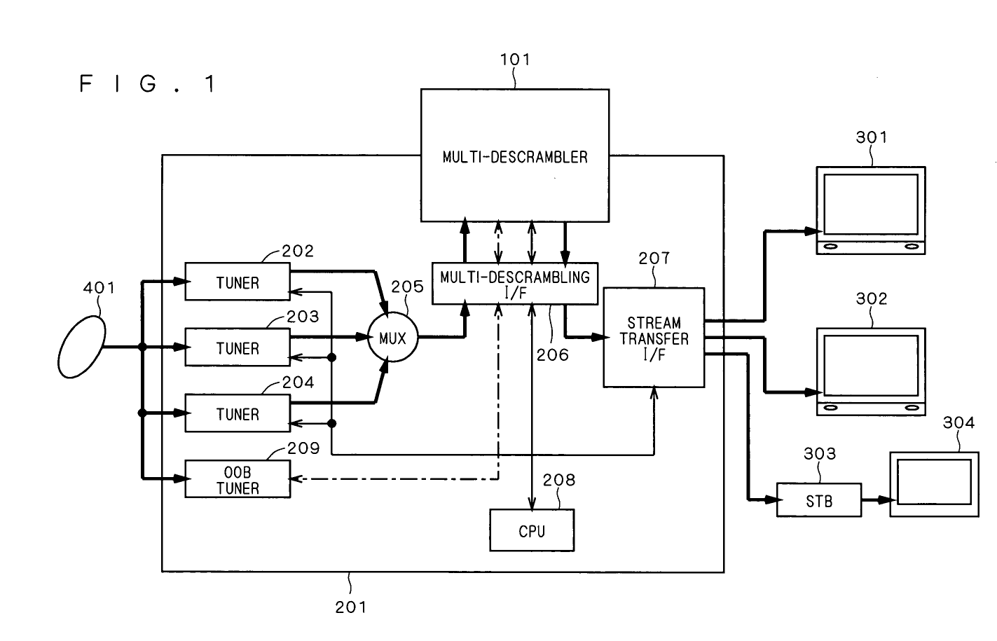

FIG. 1 is a block diagram of a system configuration using a multistream distributor 201 according to a first preferred embodiment of the present invention.

In the system configuration in FIG. 1, the multistream distributor 201 is connected to a cable network 401, receivers 301 and 302 which are TVs incorporating digital-signal decoding functions, and a receiver 303 which is an STB incorporating a digital-signal decoding function. The receiver 303 is connected to a monitor 304.

The multistream distributor 201 includes tuners 202, 203, and 204; a multiplexer 205; a multi-descrambling interface 206; a stream transfer interface 207; a CPU 208 which provides overall control of the multistream distributor 201 and exchanges information with the receivers 301 to 303; an out-of-band (OOB) tuner 209 which receives information on broadcasting, scramble information, program guide information, and the like; and a multi-descrambler 101. The multi-descrambler 101 shall consist of a CableCARD.

Referring to FIG. 1, cable broadcast signals from the cable network 401 are distributed into the tuners 202 to 204. The tuners 202 to 204 are controlled by the CPU 208 based on request of the receivers 301 to 303 so as to be capable of receiving specified channels. Transport streams (first scrambled transport streams) received from the tuners 202 to 204 are inputted into the multiplexer 205, where transport streams each are identified and attached with header information indicating the time of arrival, and are time-multiplexed into a single stream (second scrambled transport stream). For the system using a CableCARD according to this preferred embodiment, headers to be attached to transport streams shall be defined by the CableCARD Interface 2.0 Specification.

The time-multiplexed single stream is transferred over the multi-descrambling interface 206 to the multi-descrambler 101. Scrambling for distribution of broadcast signals indicates that broadcast signals are encrypted using information called scramble keys, which keys are made available to viewers under contract such as subscription to programs. Usually, scramble keys are distributed after being encrypted using information that can be known only to contractors, so that the multi-descrambler 101 obtains descramble keys for descrambling and encryption keys for encryption on the basis of contracts for each of the receivers 301 to 303.

Then, the multi-descrambler 101 time-demultiplexes the input single second scrambled transport stream into a plurality of first scrambled transport streams for descrambling (by which a plurality of descrambled transport streams are generated) and for re-encryption (by which a plurality of first encrypted transport streams are generated), and then time-multiplexes the first encrypted transport streams into a single transport stream (second encrypted transport stream).

The aforementioned acquisition of the descramble and encryption keys uses information on the receivers 301 to 303 to which transport streams are transferred. Using a different encryption key for encrypting each of the receivers 301 to 303 improves the concealment of transport streams. The descrambled and encrypted transport stream is transferred again over the multi-descrambling interface 206 to the stream transfer interface 207.

While the multi-descrambler 101, as above described, consists of a CableCARD, the multistream distributor 201 in FIG. 1 needs to be equipped with only one CableCARD of the same shape as conventional ones since transport streams to be descrambled and encrypted are inputted into the multi-descrambler 101 after being time-multiplexed by the multiplexer 205. Further, forming the multi-descrambler 101 of a card such as a CableCARD and incorporating it into the multistream distributor 201 which forms a casing allows, for example in the case of changes in descrambling techniques due to hacking or due to changes on the cable TV company side such as relocation, us to meet new descrambling techniques with ease by replacing not the whole multistream distributor 201 but only the multi-descrambler 101.

The stream transfer interface 207 time-demultiplexes the second encrypted transport stream, which has been time-multiplexed as a single stream, into a plurality of first encrypted transport streams and provides content protection as necessary to prevent unauthorized copying. Further, the stream transfer interface 207 transfers the plurality of time-demultiplexed first encrypted transport streams to the receivers 301 to 303 over IEEE 1394, Ethernet (trademark), or any other original means of connection. The stream transfer interface 207 also transfers information between the multistream distributor 201 and the receivers 301 to 303, the information including channel information received respectively at the receivers 301 to 303, descrambling information, encryption information, and information on the receivers 301 to 303 to which transport streams are transferred.

The CPU 208 manages information on transport streams and on the receivers 301 to 303 for use by the multistream distributor 201 to transfer information to the receivers 301 to 303. In order to properly transfer descrambled transport streams to the receivers 301 to 303, it is necessary to identify each of the receivers 301 to 303 and then to associate transport streams received via the tuners 202 to 204 with the receivers 301 to 303. The identification of the receivers 301 to 303 can be made using unique numbers each representing the receivers 301 to 303; for example, nodes ID or GUID defined by the IEEE 1394 standard when the multistream distributor 201 and the receivers 301 to 303 are connected over IEEE 1394; or IP or MAC addresses when they are connected over Ethernet (trademark).

In order to establish associations between transport streams and the receivers 301 to 303, the CPU 208 identifies each of the receivers 301 to 303 and assigns numbers that associate each of the identified receivers 301 to 303 to a corresponding one of the transport streams. These numbers are used as identification numbers included in headers attached to transport streams. Using the identification numbers, the CPU 208 relates received channel information, descrambling information, encryption information, and information on the receivers 301 to 303 to which transport streams are transferred. While there are three tuners 202 to 204 incorporated in FIG. 1, the number of tuners may be increased or decreased depending on system scale or the price of the multistream distributor 201. In other words, the number of tuners may be determined depending on the number of receivers to be connected.

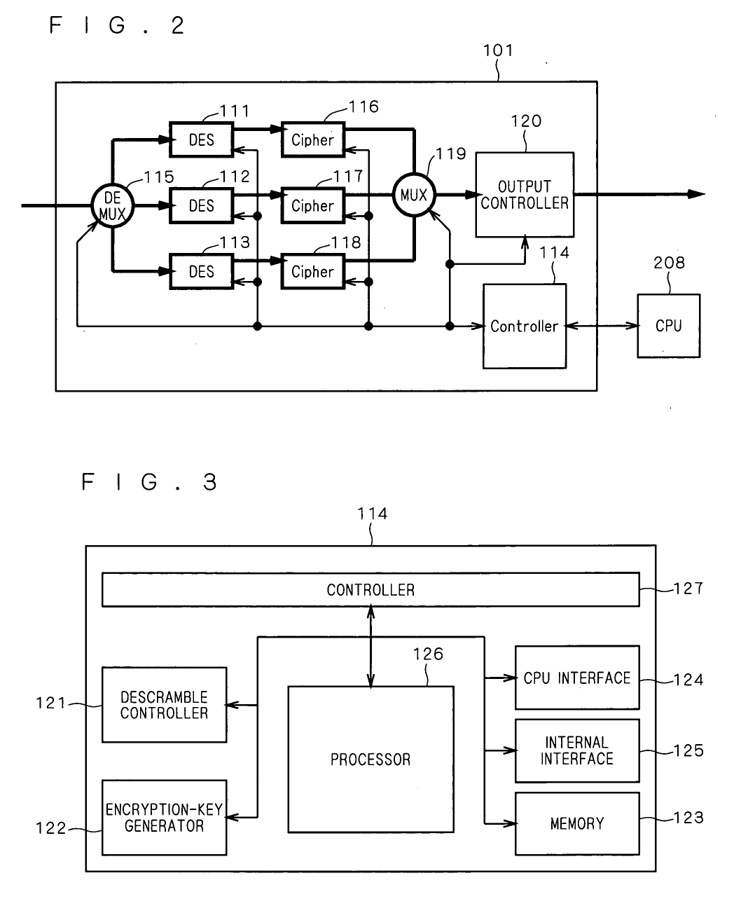

FIG. 2 is a block diagram showing a detailed structure of the multi-descrambler 101 shown in FIG. 1. The multi-descrambler 101 comprises descramble circuits 111, 112, and 113; a controller 114; a demultiplexer 115; cipher circuits 116, 117, and 118; a multiplexer 119; and an output controller 120.

The demultiplexer 115, based on information such as identification numbers included in headers attached to transport streams, time-demultiplexes the single second scrambled transport stream which has been obtained by time-multiplexing a plurality of first scrambled transport streams in the multistream distributor 201, again into a plurality of first scrambled transport streams with their original headers attached. The time-demultiplexed first scrambled transport streams are inputted into the descramble circuits 111 to 113, respectively. The descramble circuits 111 to 113 descramble the input first scrambled transport streams using received descramble keys, to generate descrambled transport streams.

The descrambled transport streams from the descramble circuits 111 to 113 are inputted into the cipher circuits 116 to 118, respectively, for encryption. Encryption keys used in the cipher circuits 116 to 118 are generated by means of key exchange that is made for encryption between the multi-descrambler 101 and the receivers 301 to 303 to which transport streams inputted into the cipher circuits 116 to 118 are transferred, respectively. This key exchange is made for each of the transport streams, and each key exchange may be performed simultaneously. Changing the aforementioned encryption keys with predetermined timing (at regular or irregular time intervals) further improves concealment of the system.

On generation of the encryption keys, referring to FIG. 1, the stream transfer interface 207 transfers information for key exchange between the multi-descrambler 101 and each of the receivers 301 to 303 under control of the CPU 208.

At this time, the multi-descrambler 101 and the CPU 208 transfer information therebetween using header information attached to transport streams, thereby to establish associations between transport streams to be encrypted and the receivers 301 to 303. Since, as previously described, the headers include the identification numbers for identifying transport streams, attaching the identification numbers to the information to be transferred between the multi-descrambler 101 and the CPU 208 allows the establishment of associations between individual transport streams to be encrypted and individual receivers. Alternatively, for example any other number unique to each receiver, instead of the identification number, may be attached to the information for establishment of associations between transport streams to be encrypted and receivers, but in that case the controller 114 needs to put the number unique to each receiver in contrast with the identification number.

The multistream distributor 201 in FIG. 1 is capable of exchanging keys with the three receivers 301 to 303, thereby to generate three encryption keys. The three encryption keys are set in the cipher circuits 116 to 118, respectively, in FIG. 2. The transport streams (first encrypted transport streams) encrypted by the cipher circuits 116 to 118 are time-multiplexed by the multiplexer 119 again into a single stream (second encrypted transport stream).

The output controller 120 outputs the second encrypted transport stream multiplexed by the multiplexer 119 out of the multi-descrambler 101 after adjusting the timing or the output bit width as necessary.

The controller 114 communicates with the CPU 208 for control of the multi-descrambler 101. More specifically, the controller 114 manages information necessary for descrambling for the descramble circuits 111 to 113, as well as handles the generation, setting, and management of encryption keys for the cipher circuits 116 to 118. While there are three descramble circuits 111 to 113 and three cipher circuits 116 to 118 incorporated in FIG. 2, the number of descramble circuits and the number of cipher circuits may be increased or decreased depending on system scale and the price of the multi-descrambler 101. In other words, the number of descramble circuits and the number of cipher circuits may be determined according to the number of receivers to be connected.

FIG. 3 is a block diagram showing a detailed structure of the controller 114 in FIG. 2. Referring to the controller 114 in FIG. 3, a descramble controller 121 generates descramble keys necessary for descrambling of transport streams based on information from the multistream distributor 201 (OOB tuner 209). An encryption-key generator 122 generates encryption keys for use in encryption between the receivers 301 to 303. A memory 123 stores execution programs for the multi-descrambler 101 as well as holds control information, the descramble keys generated in the descramble controller 121, and the encryption keys generated in the encryption-key generator 122. The descramble keys and the encryption keys are stored as distinguished from one another using the identification numbers, in order to match with the transport streams. A CPU interface 124 inputs and outputs information from and to the CPU 208. An internal interface 125 sets each of the descramble keys held in the memory 123 and each corresponding to one of the transport streams in a corresponding one of the descramble circuits 111 to 113; sets each of the encryption keys held in the memory 123 and each corresponding to one of the transport streams in a corresponding one of the cipher circuits 116 to 118; sets the other circuits within the multi-descrambler 101; and obtains the headers attached to the transport streams. A processor 126 performs computation of programs. A controller 127 controls each part of the controller 114.

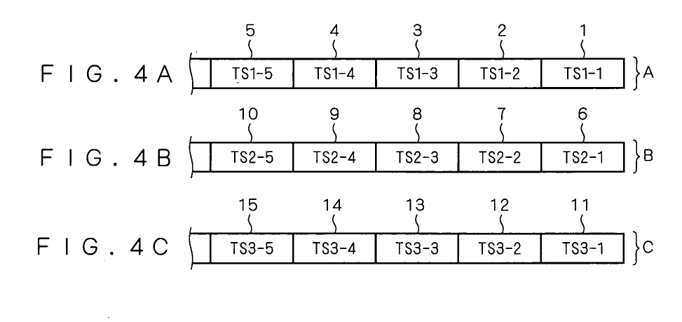

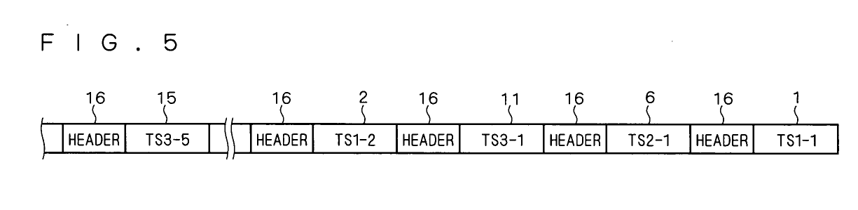

FIGS. 4A, 4B, and 4C show examples of transport streams (first scrambled transport streams) A, B, and C outputted from the tuners 202, 203, and 204, respectively. Specifically, FIG. 4A shows the transport stream A including transport stream packets 1 to 5 which are sequentially outputted from the tuner 202; FIG. 4B shows the transport stream B including transport stream packets 6 to 10 which are sequentially outputted from the tuner 203; and FIG. 4C shows the transport stream C including transport stream packets 11 to 15 which are sequentially outputted from the tuner 204.

FIG. 5 shows a single time-multiplexed transport stream (second scrambled transport stream) outputted from the multiplexer 205, with a header 16 attached to each of the transport stream packets 1 to 15 in the three transport streams A to C outputted from the tuners 202 to 204. The example of FIG. 5 shows that the transport stream packets 1 to 15 are time-multiplexed in the following order: 1, 6, 11, 2, 7, 12, 3, 8, 13, 4, 9, 14, 5, 10, and 15. The headers 16 shown in FIG. 5 shall be specified in the CableCARD Interface 2.0 Specification by CableLabs. These headers 16 each include an identification number for identifying each of the transport streams. The use of the identification numbers allows the establishment of relations among received channel information; descrambling information; encryption information; and information on receivers to which transport streams are transferred.

As so far described, the multistream distributor according to this preferred embodiment includes the multi-descrambler which descrambles and encrypts a plurality of first scrambled transport streams forming a single second scrambled transport stream in correspondence with a plurality of receivers, respectively, thereby to produce a single second encrypted transport stream out of a plurality of first encrypted transport streams. Thus, it becomes possible to select channels on the request of a plurality of receivers, to descramble and encrypt scrambled transport streams, and then to transfer different transport streams to the respective receivers. Accordingly, only one CableCARD is required to display a plurality of transport streams corresponding respectively to a plurality of channels on a plurality of receivers or the like. This results in cost reduction as compared to conventional multistream distributors which necessitate CableCARDs as many as the number of receivers.

### Second Preferred Embodiment

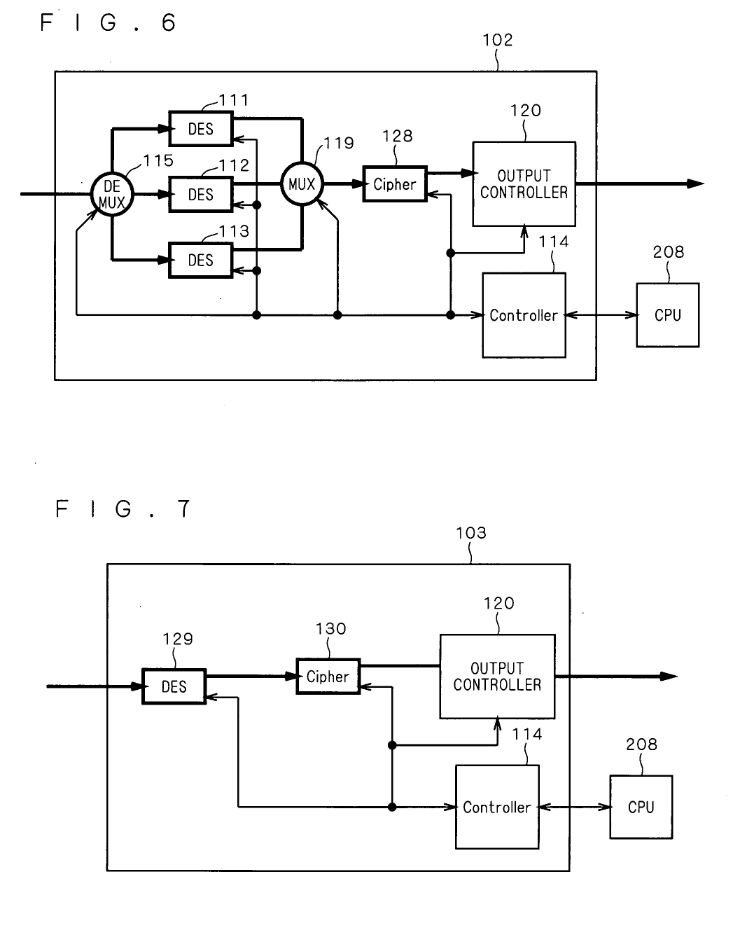

FIG. 6 is a block diagram showing a detailed structure of a multi-descrambler 102 according to a second preferred embodiment. The multi-descrambler 102 in FIG. 6 replaces three cipher circuits 116 to 118 in the multi-descrambler 101 of FIG. 2 according to the first preferred embodiment with one cipher circuit 128. Further, while the cipher circuits 116 to 118 in the multi-descrambler 101 in FIG. 2 are provided on the input side of the multiplexer 119, the cipher circuit 128 in the multi-descrambler 102 in FIG. 6 is provided on the output side of the multiplexer 119.

The multi-descrambler 101 in FIG. 2 uses the three cipher circuits 116 to 118 to encrypt input transport streams using different encryption keys (i.e., three individual encryption keys). In contrast, the multi-descrambler 102 in FIG. 6 uses only one cipher circuit 128 to encrypt transport streams using the same encryption key (common encryption key). And the multi-descrambler 102 transfers one common encryption key for encrypting transport streams to each of the receivers 301 to 303.

At this time, the controller 114 exchanges encryption keys (individual encryption keys) for use in encrypting and transferring the encryption key (common encryption key) for encrypting transport streams, with each of the receivers 301 to 303; encrypts the common encryption key for transport streams using the individual encryption keys; and transfers the encrypted common encryption key to each of the receivers 301 to 303. Since the common encryption key is exchanged between the controller 114 and each of the receivers 301 to 303, different individual encryption keys are generated for each of the receivers 301 to 303. The individual encryption keys for encrypting the common encryption key can be distinguished by referring to the identification numbers in the headers attached to the transport streams.

As described above, the multi-descrambler according to this preferred embodiment further encrypts the encryption key for encrypting transport streams, thereby reducing the number of encryption keys for encrypting transport streams to one. This reduces the number of cipher circuits, thereby resulting in further reduction in manufacturing cost as compared to the first preferred embodiment.

While, in the above description, the multi-descrambler 102 provided with only one cipher circuit 128 in FIG. 6 has been described as further encrypting the encryption key for encrypting transport streams, the present invention is not limited thereto. As an alternative, the multi-descrambler 101 provided with the three cipher circuits 116 to 118 in FIG. 2 may further encrypt the encryption key for encrypting transport streams. This reduces the number of encryption keys for encrypting transport streams to one among the three cipher circuits 116 to 118.

### Third Preferred Embodiment

FIG. 7 is a block diagram showing a detailed structure of a multi-descrambler 103 according to a third preferred embodiment. The multi-descrambler 103 in FIG. 7 replaces three descramble circuits 111 to 113 and three cipher circuits 116 to 118 in the multi-descrambler 101 in FIG. 2 according to the first preferred embodiment with one descramble circuit 129 and one cipher circuit 130, respectively, and omits the demultiplexer 115 and the multiplexer 119.

The multi-descrambler 101 in FIG. 2 individually sets descramble keys for each of the three descramble circuits 111 to 113 and individually sets encryption keys for each of the three cipher circuits 116 to 118 in correspondence with the three transport streams A to C. In contrast, the multi-descrambler 103 in FIG. 7 provided with only one descramble circuit 129 and one cipher circuit 130 changes the descramble key and the encryption key in time sequence so that a different descramble key and a different encryption key will be used for each of the transport streams A to C.

As shown in FIG. 5, the transport stream inputted into the multi-descrambler 103 is such that the transport streams A to C received via the tuners 202 to 204 respectively are time-multiplexed with the headers 16 attached thereto. Thus, the descramble key used in the descramble circuit 129 and the encryption key used in the cipher circuit 130 each are sequentially changed in time sequence for each transport stream to be descrambled in the descramble circuit 129 and to be encrypted in the cipher circuit 130, so that different descramble keys and different encryption keys can be used for each of the tuners 202 to 204 (i.e., each of the receivers 301 to 303). The changing of the descramble key used in the descramble circuit 129 and the encryption key used in the cipher circuit 130 is made under control of the controller 114 according to the identification numbers in the headers attached to the transport streams.

As described above, the multi-descrambler according to this preferred embodiment changes the descramble key and the encryption key in time sequence. This allows reduction in the numbers of cipher circuits and descramble circuits, thereby resulting in further reduction in manufacturing cost as compared to the second preferred embodiment.

While in the above description one cipher circuit 130 has been described as changing the encryption keys in time sequence in order to use different encryption keys for encryption, the present invention is not limited thereto. As an alternative, as described in the second preferred embodiment, the encryption key (common encryption key) for encrypting transport streams may be further encrypted using individual encryption keys, thereby to reduce the number of encryption keys for encrypting transport streams to one.

While the invention has been shown and described in detail, the foregoing description is in all aspects illustrative and not restrictive. It is therefore understood that numerous modifications and variations can be devised without departing from the scope of the invention.

What is claimed is:

1. A multistream distributor comprising:
a multiplexer time-multiplexing a plurality of first scrambled transport streams corresponding respectively to a plurality of receivers into one second scrambled transport stream;
a multi-descrambler descrambling and encrypting each of said plurality of first scrambled transport streams forming said one second scrambled transport stream in correspondence with each of said plurality of receivers, to generate one second encrypted transport stream consisting of a plurality of first encrypted transport streams; and
a stream transfer interface time-demultiplexing said one second encrypted transport stream into said plurality of first encrypted transport streams and inputting each of said plurality of first encrypted transport streams into a corresponding one of said plurality of receivers.

2. The multistream distributor according to claim 1,
said multistream distributor as a whole being a casing; and
said multi-descrambler being a card.

3. A multi-descrambler comprising:
a demultiplexer time-demultiplexing one second scrambled transport stream, which has been obtained by time-multiplexing a plurality of first scrambled transport streams corresponding respectively to a plurality of receivers, into said plurality of first scrambled transport streams;
a descramble circuit descrambling each of said plurality of first scrambled transport streams in correspondence with each of said plurality of receivers, to generate a plurality of descrambled transport streams;
a cipher circuit encrypting each of said plurality of descrambled transport streams in correspondence with each of said plurality of receivers, to generate a plurality of first encrypted transport streams; and
a multiplexer time-multiplexing said plurality of first encrypted transport streams into one second encrypted transport stream.

4. The multi-descrambler according to claim 3, wherein
said descramble circuit is provided for each of said plurality of receivers,
for descrambling of said plurality of first scrambled transport streams, each of said descramble circuits using a different individual descramble key for each of said plurality of receivers; and
said cipher circuit is provided for each of said plurality of receivers,
for encryption of said plurality of descrambled transport streams, each of said cipher circuits using a different individual encryption key for each of said plurality of receivers.

5. The multi-descrambler according to claim 3, wherein
said descramble circuit is provided for each of said plurality of receivers,
for descrambling of said plurality of first scrambled transport streams, each of said descramble circuits using a different individual descramble key for each of said plurality of receivers; and
said cipher circuit is provided for each of said plurality of receivers,
for encryption of said plurality of descrambled transport streams, said cipher circuits using a common encryption key for said plurality of receivers,
for encryption of said common encryption key, each of said cipher circuits using a different individual encryption key for each of said plurality of receivers.

6. The multi-descrambler according to claim 3, wherein
said descramble circuit is provided for each of said plurality of receivers,
for descrambling of said plurality of first scrambled transport streams, each of said descramble circuits using a different individual descramble key for each of said plurality of receivers; and
said cipher circuit is provided common to said plurality of receivers,
for encryption of said plurality of descrambled transport streams, said cipher circuit using a common encryption key for said plurality of receivers,
for encryption of said common encryption key, said cipher circuit using a different individual encryption key for each of said plurality of receivers.

7. The multi-descrambler according to claim 3, wherein
said descramble circuit is provided common to said plurality of receivers,
for descrambling of said plurality of first scrambled transport streams, said descramble circuit using an individual descramble key that is changed in time sequence for each of said plurality of receivers; and
said cipher circuit is provided common to said plurality of receivers,
for encryption of said plurality of descrambled transport streams, said cipher circuit using an individual encryption key that is changed in time sequence for each of said plurality of receivers.

8. The multi-descrambler according to claim 3, wherein
said descramble circuit is provided common to said plurality of receivers,
for descrambling of said plurality of first scrambled transport streams, said descramble circuit using an individual descramble key that is changed in time sequence for each of said plurality of receivers; and
said cipher circuit is provided common to said plurality of receivers,
for encryption of said plurality of descrambled transport streams, said cipher circuit using a common encryption key for said plurality of receivers,
for encryption of said common encryption key, said cipher circuit using a different individual encryption key for each of said plurality of receivers.

9. The multi-descrambler according to claim 4, wherein
said transport streams have headers attached thereto and each including an identification number corresponding to each of said plurality of receivers.

10. The multi-descrambler according to claim 5, wherein
said transport streams have headers attached thereto and each including an identification number corresponding to each of said plurality of receivers.

11. The multi-descrambler according to claim 6, wherein
said transport streams have headers attached thereto and each including an identification number corresponding to each of said plurality of receivers.

12. The multi-descrambler according to claim 7, wherein
said transport streams have headers attached thereto and each including an identification number corresponding to each of said plurality of receivers.

13. The multi-descrambler according to claim 8, wherein
said transport streams have headers attached thereto and each including an identification number corresponding to each of said plurality of receivers.

14. The multi-descrambler according to claim 4, wherein
said individual encryption key is changed with predetermined timing.
